(19) United States
(12) Patent Application Publication
(10) Pub. No.: US 2026/0284901 A1
(43) Pub. Date: Sep. 24, 2026

(54) SYSTEMS AND METHODS FOR A CONFIGURABLE HANDLE FOR ASSISTING A USER

(71) Applicant: Massachusetts Institute of Technology, Cambridge, MA (US)

(72) Inventors: Haruhiko Harry Asada, Lincoln, MA (US); Roberto A. Bolli, JR., Cambridge, MA (US)

(73) Assignee: Massachusetts Institute of Technology, Cambridge, MA (US)

(21) Appl. No.: 19/480,170

(22) PCT Filed: Apr. 17, 2024
(86) PCT No.: PCT/US2024/024846

§ 371 Date: Oct. 30, 2025

Related U.S. Application Data
(60) Provisional application No. 63/508,897, filed on Jun. 18, 2023.

(51) Int. Cl. B25J 11/00; A61H 3/04; B25J 13/08; B25J 19/02

(52) U.S. Cl. CPC B25J 11/009; A61H 3/04; B25J 13/085; B25J 19/023; A61H 2003/043; A61H 2201/1635; A61H 2201/1659; A61H 2201/5061; A61H 2201/5092

(57) ABSTRACT

Systems and methods for providing a configurable handle for assisting a user to perform an activity are disclosed. A device may include a mobile base, a robotic arm attached to and supported by the mobile base, and a handle attached to the robotic arm. The handle may be configured to be grasped by and support a user during the activity and the robotic arm may be configured to position the handle in a desired pose relative to the user during the activity. The device may be calibrated involving one or more cameras configured to image the user.

### RELATED APPLICATIONS

This application claims the benefit of priority under 35 U.S.C. § 119(e) of U.S. Provisional Application Ser. No. 63/508,897, filed Jun. 18, 2023, the disclosure of which is incorporated herein by reference in its entirety.

### FIELD

Disclosed embodiments are related to systems and methods for a configurable handle for assisting a user.

### BACKGROUND

Over 750,000 adults aged 65 or older have died of COVID 19. The pandemic has severely impacted all in-person eldercare services, including assisted living facilities, visiting nurses, and home care; people have lost care services and community interactions. In addition to the death toll, many have suffered from mental disorders due to prolonged isolation. The current work was motivated by the need to deliver high-quality eldercare services in a manner that is pandemic resilient.

Roughly 25 million Americans rely on help from caretakers and use assistive devices such as canes, raised toilets or shower seats to perform essential daily activities. Falls represent a major risk, especially for isolated seniors, as the vast majority of falls occur when an elderly person is alone. Thirty percent of people over the age of 65 fall each year, and falls are listed as a contributing factor to admissions to nursing homes in 40% of cases. In a hospital study, almost 80% of patients who fell were unassisted, and 84.7% of total falls happened in the patient's room. Lost balance was the prevailing reason given by patients, and the most common activities at the time of a fall were ambulation, getting out of bed, and sitting down or standing up—all activities requiring significant changes in body posture.

Existing elderly assistive devices are effective for specific use cases, but their applications are often limited, as shown in Table 1. Some devices, such as transfer slings, require another person to set up and deploy, and are thus of limited use outside of institutional care settings. In addition, most are tailored for only a specific task or set of tasks. A patient lift—also known as a Hoyer lift—can be used by seniors to get in and out of bed without the assistance of another person, but offers no help with toileting, ambulating, or navigation. Barrier-free home improvement provides elderly people with various supports, encompassing everything from widening doorways to installing stair lifts and replacing bathtubs with walk-in showers. While this is a good option for placing multiple assistive devices around the home, each tailored to a specific activity, the cost of such a treatment is a formidable barrier to most seniors, who have a median retirement income of $47,357/yr.

TABLE 1
Comparison of Assistive Devices

| Device | Uses | Limitations |
|---|---|---|
| Transfer | Supports transfers to/from a | Requires a human to |
| sling | bed, wheelchair, car, etc. | operate |
| Patient lift | Supports transfers in and out | Expensive; narrowly |
| (Hoyer lift) | of a bed and/or bath. | tailored for specific tasks |
| Walk-in | Allows an elderly person to | Expensive; requires home |
| shower | safely enter a shower | renovation |
| Grab bar | Provides support for various | Placement constrained by |
| | activities | room layout; only provides |
| | | support in vicinity of bar |

Widely used household balance and transfer aids include grab bara, which are often prescribed to seniors to compensate for age-related deficits. These are handlebars installed in certain locations—such as near the bathtub, on each side of the toilet, and next to doorways—that elderly people can grab for bodily support. On average, each senior installs two grab bars, especially in the bathroom, where 87% reported using them for assistance on a regular basis. Besides assisting with various tasks, they have also been shown to reduce the incidence of falls in certain scenarios. However, the placement of grab bars is a challenge since they must be rigidly attached to a nearby surface and are therefore constrained by the room layout. This sometimes leads to inappropriate bar locations for diverse activities. Since the bars are fixed, they must be installed in every high-risk area, which is often costly, and once the user is finished using a grab bar for assistance, it provides no further support for other activities. A moveable tension pole has been proposed as a means to assist with both walking and standing, though this device requires a continuous flat ceiling and cannot travel through doorways.

### SUMMARY

In some embodiments, a device comprises a mobile base; a robotic arm attached to and supported by the mobile base, wherein the robotic arm comprises a linkage; and a handle attached to the robotic arm, wherein the handle is configured to be grasped by and support a user during an activity, wherein the robotic arm is configured to position the handle in a desired pose relative to the user during the activity.

In some embodiments, a method for assisting a user during an activity comprises positioning a robotic arm using a mobile base; and positioning a handle to be grasped by a user during an activity using the robotic arm.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a perspective view of a device with a configurable handle according to some embodiments;

FIG. 2 shows a perspective view of a device with a configurable handle and a bed according to some embodiments;

FIG. 3 shows a perspective view of a device with a configurable handle and a bathtub according to some embodiments;

FIG. 4A shows a device with a configurable handle in an operating environment according to some embodiments;

FIG. 4B shows a device with a configurable handle in another operating environment according to some embodiments;

FIG. 5A shows a device with a configurable handle and sequence for assisting a user during an activity according to some embodiments;

FIG. 5B shows a device with a configurable handle in an operating environment and sequence for assisting a user during an activity according to some embodiments;

FIG. 6A shows a device with a configurable handle and a mobile drive base and a controller according to some embodiments;

FIG. 6B shows a device with a configurable handle and a mobile drive base according to some embodiments;

FIG. 6C shows a device with a configurable handle and a sensor according to some embodiments;

FIG. 7 shows a schematic control diagram of a device with a configurable handle according to some embodiments;

FIG. 8A shows a device with a configurable handle including cameras according to some embodiments;

FIG. 8B shows a device with a configurable handle including cameras from a view of one of the cameras according to some embodiments;

FIG. 9 shows a graph of experimental data of forces and torques relating to a configurable handle according to some embodiments;

FIG. 10 shows a diagram of links and associated according to some embodiments;

FIG. 11 shows a human in various poses and associated velocity vectors and centers of mass according to some embodiments;

FIG. 12 shows a diagram of robotic linkages and associated velocity vectors and center of mass and a human in a pose corresponding to the diagram according to some embodiments;

FIG. 13A shows diagrams of robotic linkages and associated velocity vectors and center of mass and a human in a first pose corresponding to the diagrams according to some embodiments;

FIG. 13B shows diagrams of robotic linkages and associated velocity vectors and center of mass and a human in a second pose corresponding to the diagrams according to some embodiments;

FIG. 13C shows diagrams of robotic linkages and associated velocity vectors and center of mass and a human in a third pose corresponding to the diagrams according to some embodiments;

FIG. 13D shows diagrams of robotic linkages and associated velocity vectors and center of mass and a human in a fourth pose corresponding to the diagrams according to some embodiments;

FIG. 14 shows forces applied to a configurable handle over time in various scenarios according to some embodiments; and

FIG. 15 shows forces applied to handles over time according to some embodiments.

### DETAILED DESCRIPTION

The desire for physical support, both to reduce falls and to improve quality of life, highlights a desire for a comprehensive assistance system that can be deployed to help elderly persons or other users navigate environments, such as a home environment. A goal of the current work is to extend the functionality of the widely used grab bars to one that can be placed anywhere within the home. It is proposed in some embodiments to use a mobile robot with a repositionable handlebar that can provide a point of support for various activities requiring postural change, including ambulation, sit/stand transfers, and toileting. The support can be both physical (through offloading body weight onto the handle) and cognitive in some embodiments, as previous research has shown that providing contact cues at the fingertip can reduce postural sway by 50-60%. In some cases, by placing the handlebar effectively based on the user's body pose, the assistance given by a human caretaker may be emulated, which remains the gold standard in eldercare. Unlike a human caretaker, the robot can provide every elderly person or other user with personalized assistance 24/7, which is useful given that 58.5% of falls occur at night (between 7 p.m. and 7 a.m.).

Safe and high-quality care services may not be reliably provided with a fully autonomous system. A human should be in the loop to monitor the robot and control its movements if necessary. Accordingly there are at least two objectives herein. One is to provide an older adult with a multi-purpose physical support system. Specifically, with a robotic handlebar. The other objective is to make the support system pandemic resilient. In-person care services may be reduced while allowing a caregiver access to older adults remotely. Here, a semi-autonomous robotic support system is developed where a remote operator, such as a caregiver, can monitor, operate, and intervene in the support services of the robot.

In the following, the design concept of a remotely controllable robotic support system is described, which may be referred to in some cases as “Handle Anywhere.” Where to place the handlebar for effectively supporting an older adult or other user according to some embodiments is also addressed. An algorithm is discussed for determining an optimal location of the handle to provide the maximal support for a group of common tasks. The proposed method of handle placement is tested experimentally using the robotic system, and the efficacy is evaluated based on quantitative metrics (e.g., force exerted on the handlebar) and qualitative feedback from the user. Furthermore, the remote operation of the system is demonstrated with a professional caregiver accessing the robot from a hospital.

### Robot Design and Implementation

The Inventors have recognized improvements to grab bars such that they can be positioned anywhere in the home. A list of functional requirements may be referenced for the design and physical dimensions of the robotic system for some embodiments based on the characteristics of people who may use the systems and methods described herein, which includes elderly people who require support and mobility assistance. These requirements may reflect the interrelated goals of utility, feasibility, and technological acceptance, and can be separated into considerations for the physical construction of the robot and its control and operation. In some embodiments, the systems and methods described herein may provide both haptic and body-weight support via a handlebar. In some embodiments, the handlebar can be positioned arbitrarily, to assist with different activities of daily living. In some embodiments, the systems and methods can be used in and navigate a standard home environment (e.g., house). In some embodiments, for safety, robot may be controlled by a caretaker if necessary. In some embodiments, the systems and methods may include remote teleoperation, so a caretaker may not need to be physically present in the same space as the user.

The Inventors have recognized systems and methods for assisting users to perform physical tasks by providing a configurable handle. The handle may be configured (e.g., positioned and/or angled) as to provide a user with physical support while performing the task. For example, the user may grasp the handle while performing the task, such as moving from a sitting position to a standing position, and the device may reduce the amount of effort required by the user to move to the standing position. The effort may be reduced variably depending on the configuration of the handle. For example, the distance between the handle and the user during the standing activity may determine at least in part how much the effort required to stand is reduced. As such, the Inventors have also recognized a need to determine a configuration of the handle to maximize the reduction in effort for the user to complete the task. The handle may be coupled to a robotic arm and the robotic arm may change poses to change the configuration of the handle. The robotic arm may be coupled to a movable base which may move to position the robotic arm. In some cases, the device may be calibrated.

The handle (e.g., handlebar) as used herein may be formed in any appropriate geometry as the disclosure is not limited in this sense. For example, the handle may be formed as a T-shape, U-shape, and/or may comprise any appropriate portions including curved or straight portions. Further, the handle may optionally be formed as a plurality of handles or handle segments. For example, two handle segments may be provided, each of which may be configured to be grasped by a hand of the user. The handle may be formed as vertically, horizontally, angularly, or some combination thereof for the user to grasp. In some cases, the handle may include a grip configured to be grasped by the user. The grip may be formed of a material (e.g., rubber, other polymer, or any other appropriate material) or textured to prevent slippage of the hand of the user on the handle.

The base as described herein may be configured to move in any appropriate fashion as the disclosure is not limited in this sense. As described herein, the base may include any appropriate wheel or combination of wheels in any appropriate quantity configured to move in one or more directions, including but not limited to Mecanum, omni, caster, and fixed wheels. In one embodiment, the base may include four Mecanum wheels and two caster wheels. In some embodiments, the base may include one or more treads of any appropriate type configured to move the base. The wheels and/or treads may be controlled in any appropriate fashion as the disclosure is not limited in this sense. For example, the wheels and/or treads may be controlled using at least one processor, which may receive movement commands manually or automatically. In cases where the base is controlled manually, the base may be controlled using at least one processor which may optionally obtain movement commands via a remote operator.

The device and methods described herein may utilize any appropriate robot or robotic limb as the disclosure is not limited in this fashion. For example, the robotic arm may include one or more of any appropriate joint type or combination of joints, including but not limited to linear, rotational, spherical, and any other appropriate type of joint. The robotic arm may include any appropriate number of degrees of freedom (DOF). For example, the robotic arm may include 1 DOF, 2 DOF, 3 DOF, 4 DOF, 5 DOF, 6 DOF, 7 DOF, 8 DOF, 9 DOF, or any other appropriate DOF. In some preferred embodiments, the robotic arm is formed with 6 DOF. The robotic arm may also include any appropriate quantity of linkages, such as 1 linkage, 2 linkages, 3 linkages, 4 linkages, 5 linkages, 6 linkages, or any other appropriate quantity of linkages. In some preferred embodiments, the robotic arm may include 2-4 linkages.

As used herein, the term “end effector” may refer to a component of a robot or device (e.g., robotic arm) configured to interact with the surrounding environment. For example, the end effector of a robotic arm may be a handle that interacts with the surrounding environment by moving to a position to provide support to a user during an activity or performing any other appropriate action to the surrounding environment commanded by an operator. As used herein, the “configuration” of a robot arm and/or a controllable portion of a robot or device may refer to relative positioning and orientation of the associated components in the robot or device. For example, for an arm including a plurality of linkages a configuration may be defined in terms of the angles between the different linkages. Thus, regardless of the specific parameters associated with a given robot or device, the configuration may describe a position and/or orientation in space of the robotic arm and/or a controlled portion of a robot or device. In some embodiments, a configuration of an end effector (e.g., handle) may include a position and/or orientation of the end effector in a world space.

As used herein, a pose may refer to a position and orientation of a component within a specific reference frame. For example, a pose of an end effector may refer to both the position and orientation of the end effector within a particular reference frame. For example, the pose of the end effector may refer to the position and orientation of the end effector in the surrounding environment. However, it should be understood for purposes of the various embodiments disclosed herein that controlling a pose of a particular component may also include controlling a position or orientation of the component as the disclosure is not limited in this fashion.

As discussed further below, determining the pose of an end effector (e.g., position and orientation of the end effector of the robot or device) may include using forward or inverse kinematics. Forward kinematics may use kinematic equations to determine the pose of an end effector using known values for joint parameters (e.g., sensed angles). Inverse kinematics may use kinematic equations to determine the joint parameters needed to achieve a corresponding end effector pose.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

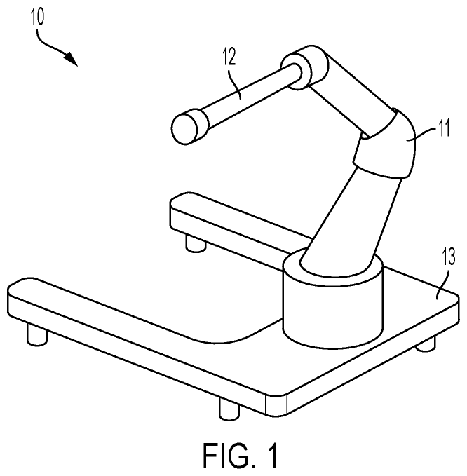

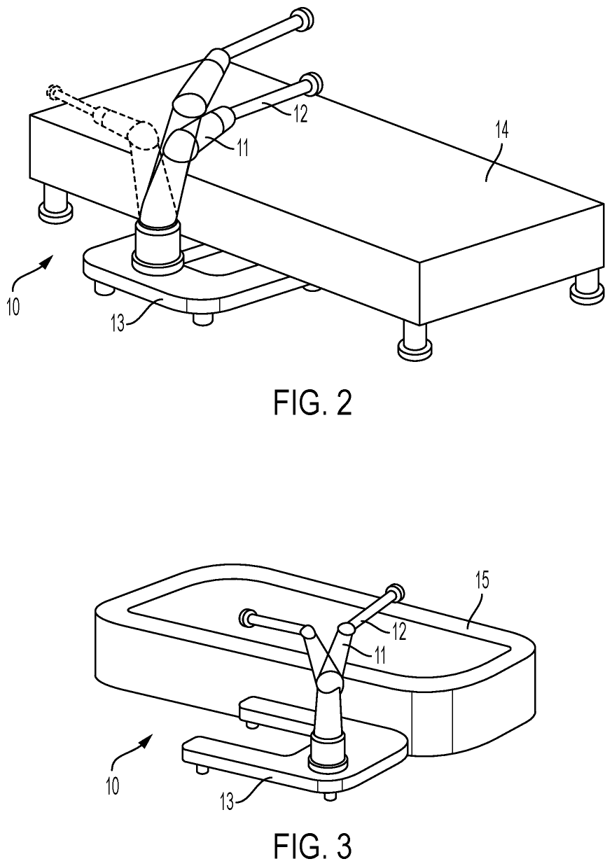

Perspective views of the device 10 according to some embodiments including the robotic arm 11 with handle 12 coupled to the mobile base 13 are shown in FIGS. 1-3. The robotic arm may be formed as any appropriate robotic arm 11 described herein. In the depicted embodiment, a bottom portion of the robotic arm 11 is coupled to the base 13. In some embodiments, the robotic arm 11 may be coupled to the base 13 via a joint, such as a rotatable joint. In the depicted embodiments of FIGS. 1-3, the robotic arm 11 includes two linkages and three joints. The linkages may be coupled via a joint. The joints may be formed with any appropriate DOF as the disclosure is not limited in this sense. The handle 12 is formed as a handlebar in the depicted embodiments of FIGS. 1-3. The handle 12 may optionally couple to the robotic arm 11 via a joint. In the depicted embodiments of FIGS. 1-3, the base 13 is formed with a main body portion and two extending portions which form a U-shape. The U-Shape may be preferable to allow space for a user to move freely proximate to the device 10 without contacting any portion of the device 10. For example, the user may be able to move between the extending portions and proximate to the robotic arm 11 and main body portion of the base 13 without contacting the device 10. The base 13 may also be formed to fit underneath furniture, such as a bed 14 as shown in FIG. 2. Being able to fit underneath furniture may enable the robotic arm 11 to operate proximate to the user to enable sufficient support while performing the activity.

It should be understood that as referred to herein, “handle” may be used interchangeably with “handlebar.”

### Example: Experimental Considerations

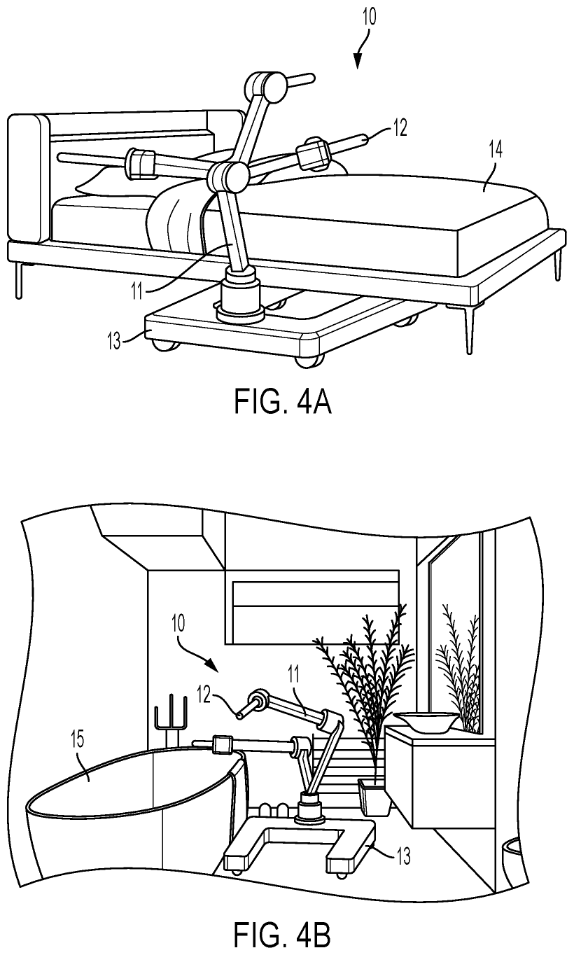

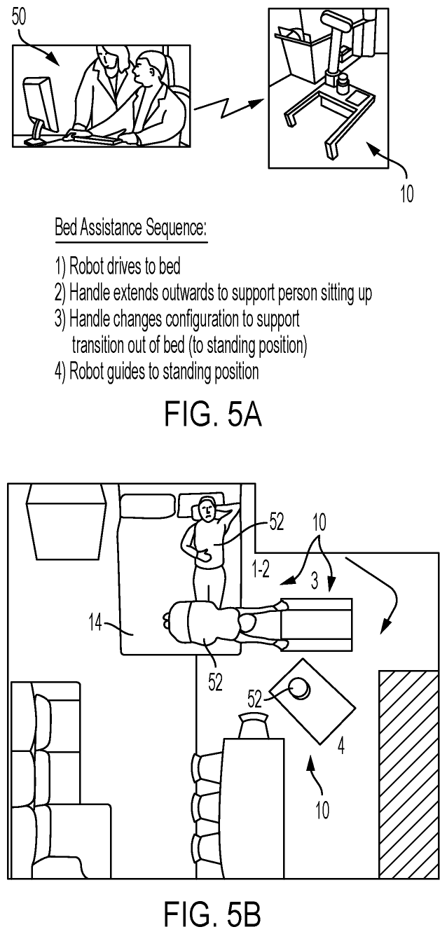

To further determine design specifications, some example use scenarios and environmental conditions were considered, as shown in FIGS. 2-4. In the examples, it was desirable for the robot 10 to be able to maneuver through a confined space such as a bathroom or a bedroom. If the elderly person is in bed 14 and desires to sit up, the device 10 may be able to place the handlebar 12 based on his or her current body position (FIGS. 2 and 4A). The handle 12 may also be able to assist the user during ambulation sequences; for example, by helping the user stand up in a bathtub 15 (FIG. 1, top pose) and then step over the bathtub lip (FIGS. 3 and 4B). In addition, the system 10 may provide the caretaker with the ability to execute a sequence of steps for a complex motion, such as getting out of bed.

### Example: Assisting a User Perform an Activity Relating to a Bed

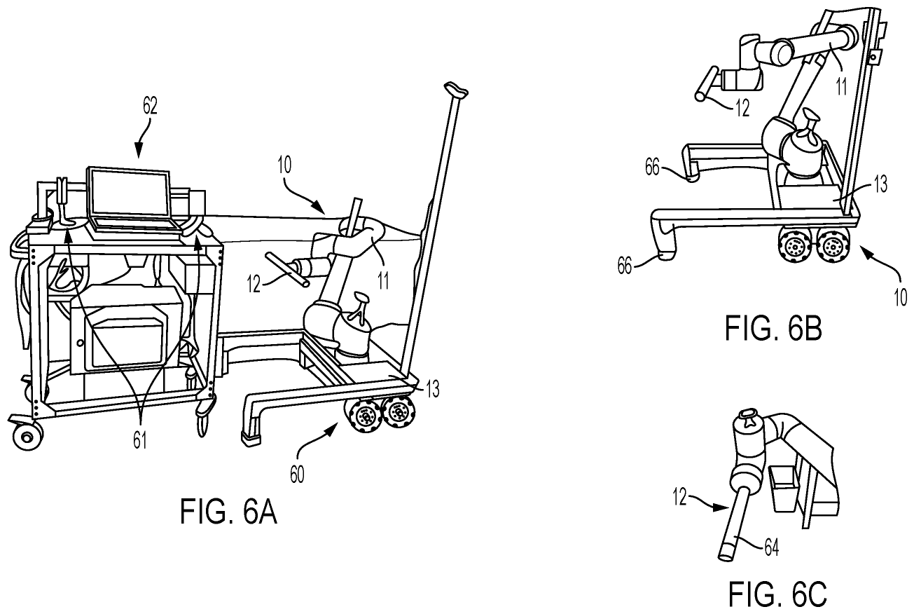

An example sequence of four unique handlebar poses for movements associated with a bed 14 is provided in FIGS. 5A-5B, including lie-to-sit support, sit-to-stand support, and assistance moving (e.g., ambulating around the room). The corresponding body poses of the user 52 at each point in the sequence are shown in FIG. 5B. In the first step of the example sequence, the device 10 may use the mobile base to move to a position which is proximate to (e.g., next to) the bed 14. In the second step of the example sequence, while in the position proximate to the bed, the device 10 may use the robotic arm to move the handle towards the user 52 such that the user 52 may grasp and be supported by the handle. The user 52 may perform the activity of transitioning from a lying position to a sitting position, while being supported by the grasped handle, thereby reducing the effort to sit up in the bed 14. In the third step of the example sequence, the device 10 may use the robotic arm and/or the mobile base to position the handle proximate to the user such that the user may grasp and be supported by the handle while transitioning from the sitting position to a standing position. As described herein, the handle may remain stationary (e.g., fixed) while supporting the user to perform an activity, including the lie-to-sit transition of step 2 of the example sequence and sit-to-stand transition of step 3 of the example sequence. Alternatively, the device 10 may move to help the user 52 to stand out of the bed 14, such as in step 4 of the example sequence. The device 10 may also support the user 52 while the user 52 moves (e.g., walks) around the room, in some cases by moving the handle/device using the mobile base as shown in FIG. 5B. The example sequence may be performed by a remote operator 50 that control the device 10.

### Example: Prototype Device with Remote Control

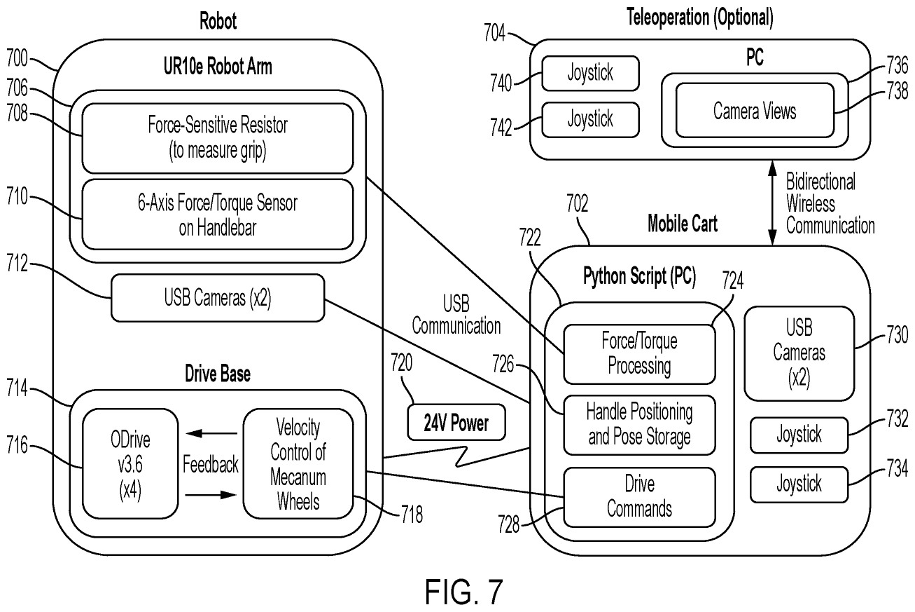

The desired functionalities as discussed herein were be realized in an example implementation of a robotic system 10, including a 6-DOF Universal Robotics UR10e arm 11 mounted on a base (e.g., a custom-made omnidirectional vehicle) 13 with four Mecanum wheels 60 (FIGS. 6A-6B). The base 13 may also include one or more ball bearings, wheels, treads, or other mechanism for enabling movement positioned on a portion of the device 10 that is different than the wheel 60. For example, in the depicted embodiments of FIGS. 6A-6C, a castor ball 66 is positioned on each extending portion of the base 13. The castor balls 66 may be configured to enable movement of the base 13 and the device 10 by, for example, rolling along the ground, and may be driven by the wheels 60. Other wheels may be used, for example, off-the shelf wheels configured to move in one or more directions. Further, any other appropriate means for moving the mobile base 13, device 10, and/or robotic arm 11 may be used, such as treads. In some embodiments, the inclusion of a flat, U-shaped base 13 which may fit underneath common furniture such as beds, tables in any appropriate configurations, may provide a space for the elderly person or other user to stand in. A T-shaped handlebar 12 instrumented with a 6-DOF force/torque sensor and one or more embedded grip sensors 64 may be formed at the end (e.g., on an end effector) of the robotic arm 11, such as on the handle 12. It should be appreciated that any appropriate handle of any appropriate geometry may be used with the systems and methods described herein, including but not limited to a curved handle (e.g., a U-shaped handle), or any other appropriate handle or plurality of handles. In some cases, it may be preferable to use a handle with a cylindrical cross-section for ease of gripping. In some cases, the handle may preferably be formed with a cylindrical cross section having a diameter of about 1.1 inches to about 1.5 inches.

### Example: Device Control

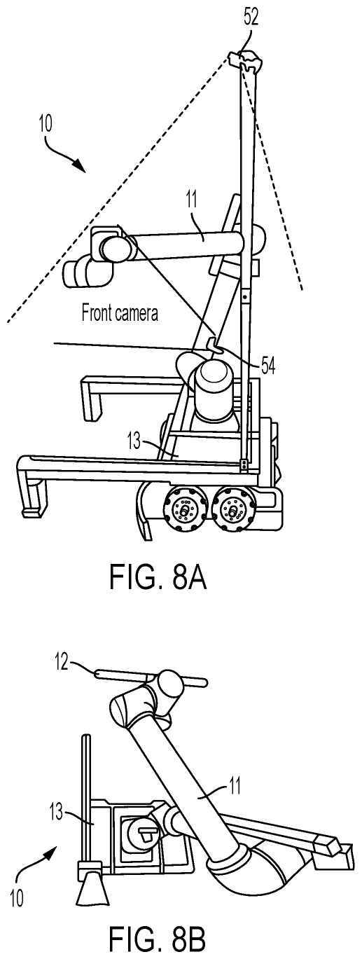

A control schematic showing an example embodiment of elements related to controlling the device described herein is shown in the depicted embodiment of FIG. 7. The device or robot 700 may include a robotic arm 706 (e.g., UR10e robot arm), which may include a sensor 708 configured to measure forces associated with a grip of a user. The robot arm 706 may also include a sensor 706 (e.g., 6-axis force/torque sensor) configured to measure force and/or torque associated with supporting the user. The device 700 may also include one or more cameras 712. The device 700 may also include a base 714 (e.g., mobile or drive base) which may include one or more (e.g., four) processors (e.g., ODrive v3.6 or any other appropriate processor) 716 which may be configured to control the velocity of the base 714 (e.g., of one or more wheels or other movement mechanisms), optionally using feedback collected from one or more sensors 718 configured to sense the velocity of the base 714.

A control system 702 may be operatively coupled to the device 700, and may optionally provide 24V power 720 (or power of any other appropriate voltage, such as 12V) to the device 700. The control system 702 (e.g., a mobile cart including elements for controlling the device 700) may include an algorithm (e.g., a python script or any other appropriate coding language) 722 which may be configured to perform force and/or torque processing 724 in relation to the sensor 708. For example, the force and/or torque processing 724 may be configured to obtain sensed forces and/or torques from the sensor 708. The algorithm 722 may be configured to store handle positions and/or poses 726 in connection with the handle of the device 700. The algorithm 722 may also be configured to provide movement commands (e.g., drive commands) 728 to the base 714. The control system 702 may also optionally include one or more control devices 732, 734, such as joysticks, configured to control any appropriate portion (e.g., robot arm 706 and/or base 714) of the device 700. The control system may be configured to obtain images from the one or more cameras 712 at 730. The obtained images may optionally be provided to an operator of the control system 702. Optionally, the control system 702 may include one or more cameras configured to image the user and/or environment.

Optionally, the device 700 may be controlled remotely via teleoperation control system 704. The teleoperation control system 704 may include one or more control devices 740, 742, such as joysticks, configured to provide commands to the control system 702 and/or the device 700. For example, the teleoperation control system 704 may be configured to control the robotic arm 706 and/or the base 714. The teleoperation control system 704 may include at least one processor and/or computer 736, which may be configured to obtain images 738 from one or more of the cameras of the device 700 and/or control system 702. The teleoperation control system 704 may be configured to control the control system 702 and/or device 700 wirelessly.

### Example: Cameras

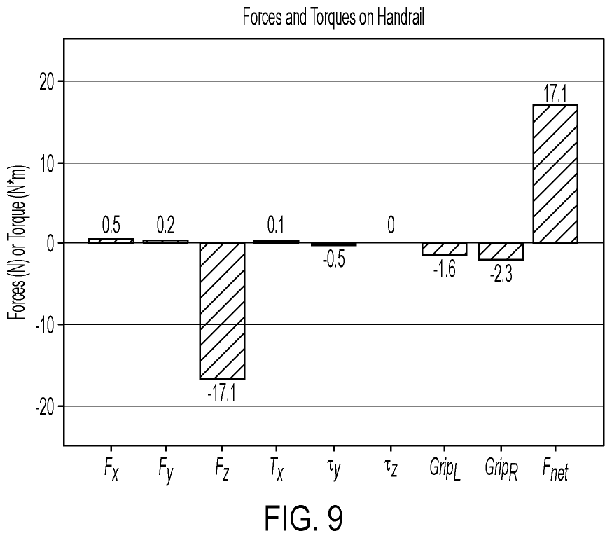

The device 10 described herein may include one or more cameras 52, 54 according to some embodiments, such as the depicted embodiments of FIGS. 8A-8B. In some cases, the device 10 may include a first camera 52 configured to image the device 10, user, and/or surrounding environment from a top down view, such as the captured image shown in FIG. 8B which includes the device 10 and the environment which the device 10 is disposed in. The device 10 may also include a second camera 54 configured to obtain an image from an angle which is different than the image obtained by the first camera 52. In some cases, one or both of the first camera 52 and the second camera 54 may be wide-angle cameras. For example, in some embodiments, the first camera 52 is a wide angle camera and the second camera 54 is a camera with a standard field of view. In some cases, the second camera 54 may be configured to image a space in front of the device 10, which in some cases may be a side of the device including the extending portions of the base 13, and/or the space in which the handle 12 is positioned for the user to grasp the handle 12. As discussed herein, images obtained by the cameras 52, 54 may be provided to an operator in some cases.

The use of a UR10e, or other appropriate robotic arm, may allow the handle to be placed in any arbitrary position and orientation. One or both of the vehicle and the handlebar may be padded with thick foam to reduce the chance of injury; in the case of the handle, this may also serve to increase grip friction and prevent the user's hands from slipping according to some embodiments. The dimensions of the drive base and handle, presented in Table 2, may be chosen in some cases based on empirical ergonomics research and typical home layout constraints. In addition, the UR10e or other robotic arm control box (e.g., at least one processor configured to control the robotic arm) and all power equipment may be mounted on a battery powered mobile cart to make the robot more compact and maneuverable according to some embodiments.

TABLE 2
Possible Dimensions

| Dimension | Value | Rationale |
|---|---|---|
| Drive base width | 66 cm | Most common home doorways are ≥ |
| | | 71 cm (28″) wide |
| Drive base length | 84 cm | Allows for a 48 cm U-shaped drive |
| | | base for elderly person to |
| | | stand/walk in |
| Handle length | 46 cm | Sufficient for a two-handed grip |
| Handle diameter | 3.8 cm | Ergonomics studies suggest an |
| | | optimal range of 3.56-4.06 cm |
| Handle reach from | 44 cm | Limited to this value to prevent the |
| robot | | robot from tipping |

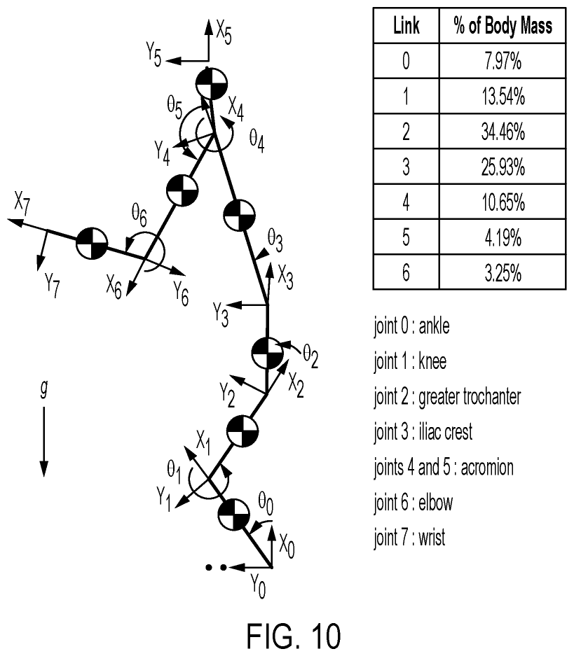

To satisfy the requirements for versatility and human-in-the-loop control, as well as for remote teleoperation, a semiautonomous control scheme may be adopted where the robot movement may be overseen and controlled by a human operator with various tools (FIG. 6A), in a form of human supervisory control. This scheme may allow a caretaker to monitor/assist a patient's movements remotely and tune the system when they are present in person. The teleoperation paradigm may be a step towards pandemic-resilient eldercare since the system enables a caregiver to physically support elderly users without having to be present. Four camera views (two from the robot, two from the cart) along with a graph of the 6-axis force and torque data, grip strength on the left and right of the handle, and net applied force (FIG. 9) may be transmitted to a remote computer in some embodiments. The cameras 52, 54 may be mounted to provide a front view of the patient as well as a wide-angle view of the robot and its surroundings according to some embodiments. For example, one or more cameras may be configured to obtain an image of the user. Joysticks 61 or any other appropriate control interface may be used for human control of the robot according to some embodiments. The operator may change one or more of the handlebar's height and distance from the center of the robot arm, and rotation relative to the mobile base. The actuators may be controlled by either position or velocity control, optionally with a safety stop to prevent injury to the user. Since the mobile base may allow for holonomic movement, each degree of freedom may be mapped to a 3-axis joystick (the 3^{rd} axis being the rotation of the joystick itself) in some cases. In addition, the robot may have the capability to switch to “freedrive” mode, whereby the handlebar could be manually positioned by an in-person caretaker according to some embodiments. This may allow for the user's preferred handlebar placements to be saved and retrieved from memory.

A live bidirectional audio and visual link may enable the caretaker to communicate with the user, which may allow the caretaker to receive consent for each movement according to some embodiments. Depending on the user's feedback (e.g., physical or audio cues observed by the system), the caretaker may modify the handle's position to better support the patient. Continuous force and grip monitoring may alert the operator when the user grabbed or released the handle, and if the net handlebar force exceeded the payload of the UR10e or other robotic arm, the system may enter a protective stop according to some embodiments.

While the robot hardware may allow for the handlebar to be used to apply a force on the user (e.g., pulling them up from a chair), the handlebar may be constrained to be completely stationary while the user grips the handlebar according to some embodiments. In some cases, elderly adults may be afraid of assistive devices that move when they are not expecting it, as they fear such a movement might cause a fall or a slip. Since users may shift a significant amount of their body weight onto the handlebar, a stationary handle may be perceived as safer and more trustworthy by the user, especially since elderly adults are typically familiar with grab bars. Therefore, to increase adoption of the robot system and to minimize the possibility of the robot triggering a fall, the handlebar may be rigidly fixed in place while it actively supported the user in some cases.

The robot system was tested remotely by a physical therapist and was confirmed to work as a proof-of-concept. The physical therapist was able to successfully drive the robot and position the handlebar to assist with toileting and bathing. Future work may involve eliminating the mobile cart 62 so that the robot can be untethered. Additionally, methods to safely move the handrail while it is being grabbed, so the robot can actively move or reposition the user may be investigated.

### Example: Optimization of Handle Location

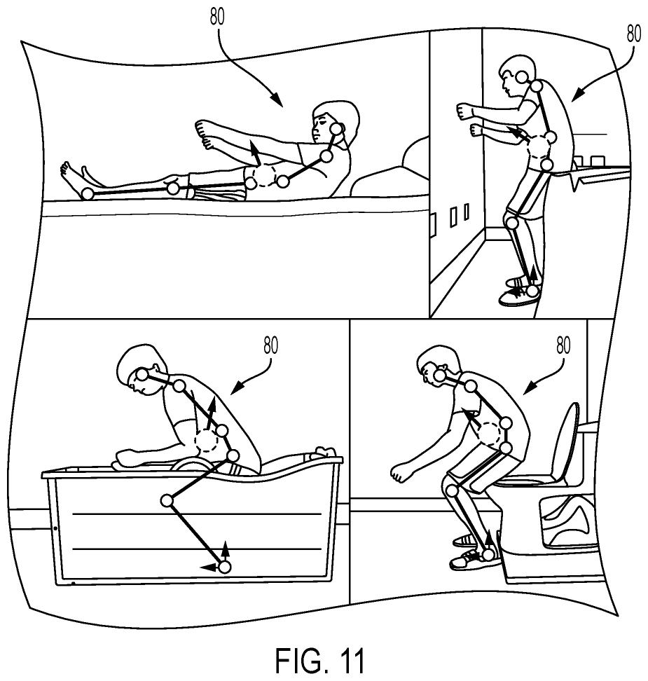

To maximize the utility provided by the handle anywhere robot, a mathematical model may be used to position the handlebar based on the body pose requiring the most muscle effort for the activity the user is performing in some embodiments. As explained herein, the only scenario discussed in relation to the mathematics presented herein is where the handle is stationary. The human body may be modeled as a 7-bar linkage (FIG. 10), confining body movement to the sagittal plane and assuming that both arms move simultaneously. In the depicted embodiment of FIG. 10, a local direction of gravity may act in the direction indicated by the arrow labeled “g”. Human arm muscle effort may be represented via joint torques τ₅, τ₆, and τ₇, acting on θ₅, θ₆, and the end of link 6 (at the origin of frame x₇, y₇), respectively. The joint representation may be such that both θ₄ and θ₅ are measured from the coordinate frame x₄, y₄ so that the arm and head angles are relative to the trunk. Each of the links may be given a mass based on the physical composition of the corresponding part of the human body, with some links absorbing the mass of multiple body parts (FIG. 10). For this study, the mass of each link was determined by estimation from an adult volunteer (23 years old, 60 kg), and all masses were normalized so that the sum of the links was the total mass of the body.

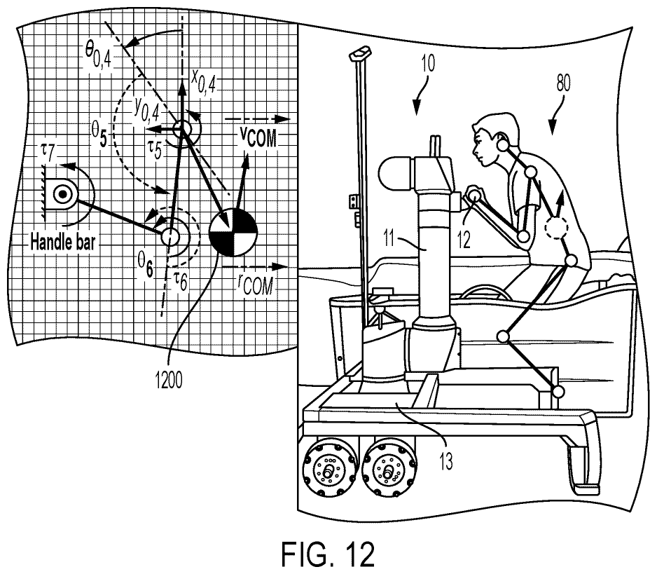

Applying the 7-bar linkage model to a person holding onto a handlebar results in a closed-loop kinematic chain, which may yield complex equations of motion and force/torque interactions. To simplify this, for each activity, only the body pose requiring the most muscle effort was analyzed. Four scenarios were selected as representative and diverse examples of ambulation activities that elderly people have difficulty performing: lie-to-sit in a bed, sit-to-stand in a bed, standing up in a bathtub, and sit-to-stand from a toilet. The volunteer 80 shown in the figures was filmed in the sagittal plane performing each scenario without any assistance. Afterwards, the volunteer identified the body poses that required the maximal muscle exertion, which are shown in FIG. 11. The applicability of this data to elderly people is discussed below.

Introducing a handlebar presents another challenge for the analysis: during each motion, if the user grabs onto the handlebar, the body pose requiring the maximal muscle effort will likely be different from the poses identified in FIG. 11, as the user would change the location of his/her arms (and possibly trunk) to reach the handlebar. This means that the pose of most effort would be dependent on the location of the handlebar. To avoid this, two constraints are introduced: first, all possible handlebar locations are limited to be within reach of the arms (links 5 and 6) and it is assumed that the user will grab the handle by moving only their arms. Second, the analysis is based on the body pose of the remaining five links, which account for all parts of the body except the arms. Since this encompasses almost 93% of the total body mass, little information is lost. The center of mass (COM) of these five links (1) is calculated, where xᵢ and yᵢ are the locations of the center of mass of each linkage, and M is the total mass of the test subject. The orientation and COM of the first five links during each of the four scenarios is shown in FIG. 11.

$$\begin{matrix}{X}_{COM} = \frac{1}{M} {{\sum }^{4}}_{i = 0} {m}_{i} {x}_{i} \\ {Y}_{COM} = \frac{1}{M} {{\sum }^{4}}_{i = 0} {m}_{i} {y}_{i}\end{matrix} \qquad ( 1 )$$

The normalized velocity vector of the first five links is also calculated by analyzing several frames of a recording of the volunteer performing each scenario, and tracing the motion of a body marker in the frames immediately preceding and following the pose that yielded the volunteer's maximal exertion. Since any human would have some intended motion to achieve during each scenario, these two measures—COM position and velocity—give an idea of the volunteer's instantaneous body trajectory.

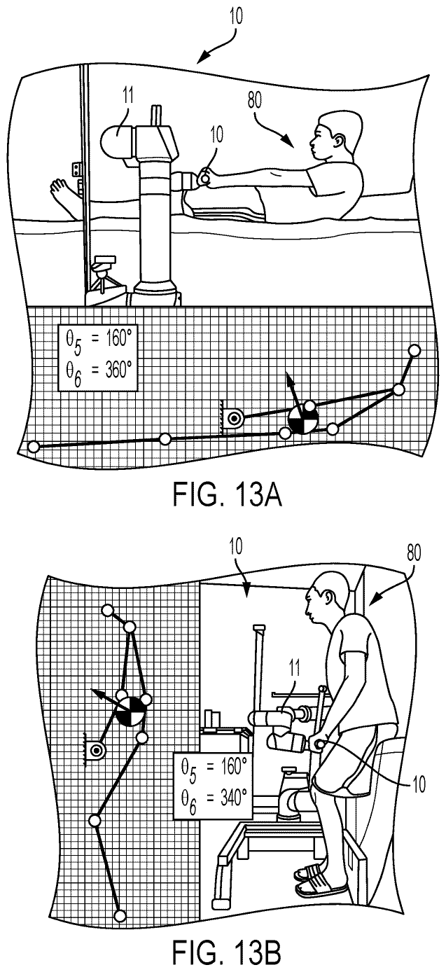

As stated earlier, when the user grabs the handlebar, a closed-loop kinematic chain is formed with the handlebar and the ground. To reduce the complexity this causes, the first five links in the body are condensed into a single point mass located at (X_{COM}, Y_{COM}) with velocity v_{COM} (FIG. 12). We can then simplify the human body model into a three-bar serial linkage consisting of links 6, 5, and a virtual link r_{COM} from link 5 to (X_{COM}, Y_{COM}). The origin of the linkage is located at the handlebar. Thus, given a body pose, an acceptable handlebar location can be calculated by choosing θ₅ and θ₆ and using forward kinematics.

With the handlebar fixed in place, an older adult can generate a force Farm at their COM (labeled as 1200 in FIG. 12) via arm joint torques τ5, τ6, and τ7 (2), allowing them to move their body in an intended direction. This force is given by the Jacobian J of the three-bar linkage in FIG. 12.

$${F}_{arm} = {( {JJ}^{T} )}^{- 1} J ( \begin{matrix}{τ}_{γ} \\ {τ}_{6} \\ {τ}_{5}\end{matrix} ) \qquad ( 2 )$$

The expanded form of (2) is shown in equation (3). For convenience in the calculations, a coordinate frame x_{0,4}, y_{0,4} at the same origin as x₄, y₄ is created with axes aligned with x₀, y₀, so that θ_{0,4} is the angle between the two frames (FIG. 12). The angle θCOM of r_{COM} is then defined with respect to x_{0,4}, y_{0,4}. Links 5 and 6 are denoted by the vectors \vec{ }r5 and \vec{ }r₆.

$$\begin{matrix}{F}_{arm} = \frac{{τ}_{5}}{\vert \vec{{r}_{COM}} \vert} [ \begin{matrix}- sin {θ}_{COM} \\ cos {θ}_{COM}\end{matrix} ] + \frac{{τ}_{6}}{\vert \vec{{r}_{COM}} - \vec{{r}_{5}} \vert} [ \begin{matrix}- sin {θ}_{θ , COM} \\ cos {θ}_{θ , COM}\end{matrix} ] + \frac{{τ}_{7}}{\vert \vec{{r}_{COM}} - \vec{{r}_{5}} - \vec{{r}_{6}} \vert} [ \begin{matrix}- sin {θ}_{7 , COM} \\ cos {θ}_{7 , COM}\end{matrix} ] \\ where \\ \begin{matrix}{θ}_{θ , COM} = {θ}_{0 , 4} + {θ}_{5} - π - {cos}^{- 1} ( \frac{{\vert \vec{{r}_{5}} \vert}^{2} + {\vert \vec{{r}_{COM}} - \vec{{r}_{5}} \vert}^{2} - {\vert \vec{{r}_{COM}} \vert}^{2}}{2 \vert \vec{{r}_{5}} \vert \vert \vec{{r}_{COM}} - \vec{{r}_{5}} \vert} ) \\ {θ}_{7 , COM} = {θ}_{0 , 4} + {θ}_{5} + {θ}_{6} - π + {cos}^{- 1} ( \frac{{\vert \vec{{r}_{6}} \vert}^{2} + {\vert \vec{{r}_{COM}} - \vec{{r}_{5}} - \vec{{r}_{6}} \vert}^{2} - {\vert \vec{{r}_{COM}} - \vec{{r}_{5}} \vert}^{2}}{2 \vert \vec{{r}_{5}} \vert \vert \vec{{r}_{COM}} - \vec{{r}_{5}} - \vec{{r}_{6}} \vert} )\end{matrix}\end{matrix} \qquad ( 3 )$$

At the desired handrail location, |Farm| should be as large as possible to provide the user with the most assistance in moving their body, and the vectors Farm and v_{COM} should be aligned so that the body can be moved in the intended direction. In other words, the goal is to maximize the inner product of Farm and v_{COM}. It is also desired to locate the handrail a comfortable distance away from the user's shoulder—not too close and not too far—so that the handlebar can support the user throughout the motion. Therefore, a penalty for extremely proximal or distant handrail placements is introduced, which simplifies kinematically to a relationship with |cos θ₆|. This optimization problem is formulated in (4), with the constant a=0.2 chosen to weigh the distance penalty appropriately.

$$arg max ( {F}_{arm} \cdot \vec{{v}_{COM}} - a \vert cos {θ}_{6} \vert ) \qquad ( 4 )$$

As a simplifying approximation, it is assumed that the joint torques are independent of the arm angles θ₅ and θ₆; that is, that a human could produce a given joint torque with roughly equivalent muscle exertion when their arm is in different positions. This allows the joint torques to be treated as constants that are either positive or negative, since in the optimization, the magnitude of the joint torque has no effect on the optimal handle position. This is due to the use of the inner product in (4). For each joint, as long as the corresponding direction of the force vector on the COM is within ±90° of v_{COM}, the inner product will be positive; therefore, in any numerical simulation to find the global maximum of (4), the torques will always take on the maximum positive or minimum negative value within the provided range. As an alternative explanation of why this occurs, it is noted that the assumption that joint torques are independent of arm angles means that in the model, each arm joint can produce some maximum torque independent of the arm configuration. These torques collectively act to produce a force Fₐᵣₘ at the COM (the “endpoint” of the arm linkage). The effect of the inner product of Farm and v_{COM} is to position the arm to maximize Farm in the direction of the COM velocity.

Eq. 4 can be viewed as a tradeoff between the mechanical advantage and proximity of the arm configuration, which is determined by the handrail location. The mechanical advantage of the arm is defined as (5), where |τ| is the norm of the arm joint torques τ5, τ6, and τ7. However, since the magnitude of the joint torques does not affect the result of the optimization in (4), as explained previously, τ5, τ6, and τ7 may be chosen to be constants that are either positive or negative, meaning that |τ| is also constant.

$$\frac{\vert {F}_{arm} \vert}{\vert τ \vert} = c \vert {F}_{arm} \vert \qquad ( 5 )$$

It is noted that since Farm and \vec{ }v\vec{ }\vec{ }C\vec{ }\vec{ }O\vec{ }\vec{ }\vec{ }M\vec{ } are both real, the inner product can be written as (6), where θVF is the angle between the two vectors.

$${F}_{arm} \cdot \vec{{v}_{COM}} = \vert {F}_{arm} \vert \vert \vec{{v}_{COM}} \vert cos {θ}_{VF} = c \vert {F}_{arm} \vert cos {θ}_{VF} \qquad ( 6 )$$

The magnitude of v_{COM} is independent of any of the parameters being optimized, and remains constant for each scenario. Comparing (5) and (6), we see that through the inner product, the mechanical advantage in the direction of v_{COM} is essentially being calculated.

A numerical simulation was set up in Matlab to determine the optimal joint angles θ₅ and θ₆ based on the cost function (4). Limits were placed on the joints' range of motion to avoid solutions that were not physically achievable. To find the global optimum handlebar location, all permissible values of 05 and 06 were iterated over with a sufficiently small step size. For all of the scenarios, the simulation successfully converged to a unique solution; these are evaluated below.

### Example: Experimental Results

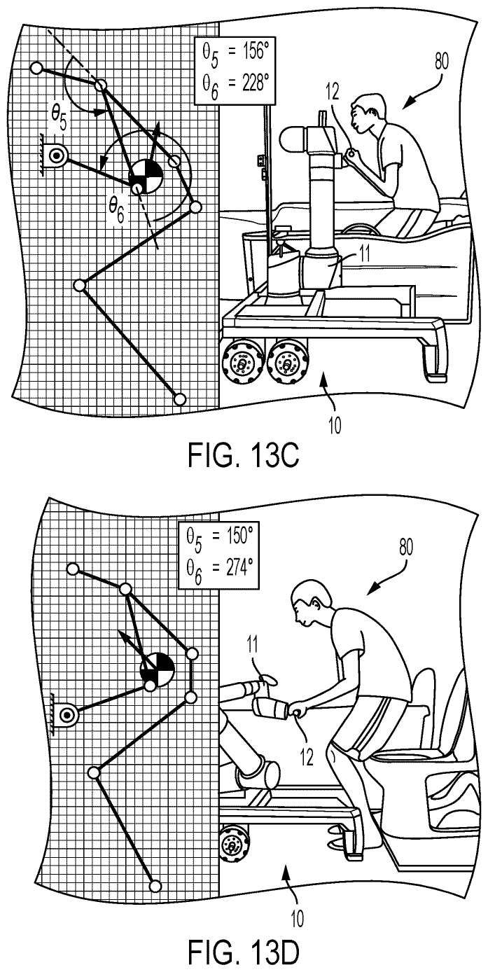

Using the methodology in the previous section, a pose for the handle in each of the four scenarios is calculated. The predicted poses appeared to be physically reasonable, directing the arm strength in the proper direction. This was confirmed when the scenarios were reenacted with the handle 12 in place, as shown in FIGS. 13A-13D. In every case, the subject 80 was able to grab the handlebar 12 and complete the body motion naturally, following the same trajectory as without the handlebar.

Previous studies by the US military have quantified arm strength in various directions based on the degree of elbow flexion. The data show that push/pull force increases as the arm extends, while up/down force peaks when the arm is bent at 90°. Looking at the COM velocity vectors in FIGS. 13A-13D, the top two scenarios mainly involve rotating the body around the contact point (the buttocks), so the push/pull force should be maximized. Meanwhile, in the bottom two scenarios, the arm assists with lifting the body upwards. Thus, the handle placements yield arm configurations which optimize strength in the desired directions, in line with the military studies' measured arm strength data.

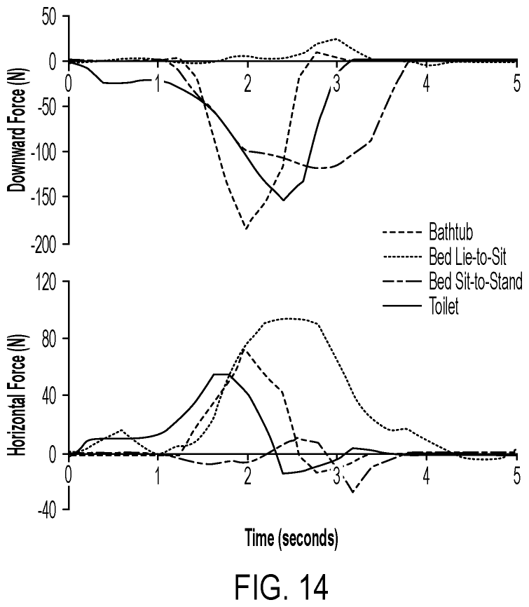

To evaluate the effectiveness of the handlebar, measurements of the force applied on the bar during each motion were taken (FIG. 14). Compared to the baseline of no handle assistance, these measurements give an idea of how much body weight the subject offloaded onto the handle. For three of the four scenarios, a significant amount of downward force was applied to the handlebar, with the arms supporting a maximum of 20-30% of the total body weight. Since the legs are able to exert roughly 4× more force than the arms, this means that the maximal muscle effort was relatively equally distributed between the arms and the legs. In the fourth scenario (bed lie-to-sit), the movement mainly involved rotation around the hips, so the applied force was predominantly in the horizontal direction. The horizontal forces in the other scenarios represent arm assistance towards maintaining the COM trajectory, such as pulling the arms forward to stand up.

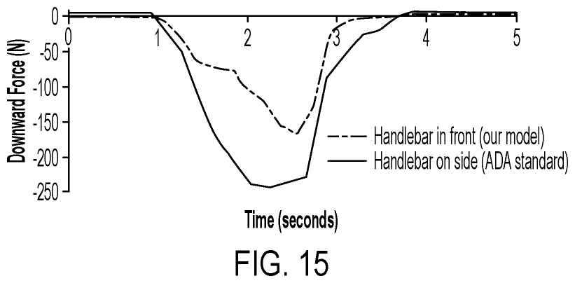

Additionally, for the toilet scenario, the calculated handlebar placement (in front of the user) was compared to the government standard for toilet handrails (on the side). FIG. 15 shows that the test subject applied significantly more force on the side-facing bar as compared to the front-facing bar, with the arms supporting a maximum of 41% of the total body weight. This indicates that the standard toilet grab bar placement leads to a highly unequally distributed muscle effort. By contrast, the calculated front-facing handle position led to a maximal arm support of 25% of the body weight, enabling the user to leverage their leg muscles more effectively for the sit-to-stand movement.

Lastly, the test subject self-reported the difficulty of executing each scenario with and without the handlebar (Table 3). This helped to reveal any qualitative differences in muscle exertion or overall patient comfort that were not captured in the force data. In all circumstances, the handlebar lowered the perceived difficulty of performing each task, moving three out of four scenarios to the “easiest” rating. The difference was greatest for the lie-to-sit task, likely due to the intense abdominal muscle strain necessary to move the trunk to the upright position. Overall, the responses indicate that the system is likely to be readily adopted, especially by users who have difficulty performing some or all of the four scenarios studied.

TABLE 3
Subjective Difficulty of Performing Tasks. Where
1 = Easiest and 5 = Hardest

| | Difficulty without | Difficulty with |
|---|---|---|
| Scenario | handlebar | handlebar |
| Lie-to-sit in a bed | 5 | 2 |
| Sit-to-stand in a bed | 2 | 1 |
| Standing up in a bathtub | 3 | 1 |
| Sit-to-stand from a toilet | 2 | 1 |

In some embodiments, a mobile robot (“Handle Anywhere”) capable of satisfying the identified functional requirements was developed; namely, to provide a repositionable handlebar for a user and to facilitate remote monitoring and assistance. To maximize the utility provided by the handlebar, a methodology was developed to locate the bar based on the body pose requiring the highest muscle effort for the activity the user was performing according to some embodiments. In experimental trials of four activities of daily living, the calculated handlebar locations were successful at offloading a significant portion of body weight and reducing the perceived effort required to perform each activity. The robot may be employed to provide bodily support to the elderly, with the goal of assisting activities requiring postural changes and reducing the incidence of falls in some cases.

The current experimental results are for a healthy young adult. It is likely that the poses of maximal effort for each activity would be different in an elderly person. However, it is believed that this does not impact the validity of the methodology, as it could still be used to generate handlebar locations based on the body pose of the elderly person. To address this, studies may be conducted with older adults having various age-related disorders. Another limitation to the current work is the representation of muscle effort as pose-independent joint torques. A musculoskeletal model may be used to better understand the effect of the handlebar upon individual muscles.

This technology may be a step towards pandemic-resilient eldercare devices: assistive tools caregivers can use to maintain a high level of care during periods of physical isolation. Specifically, mobile handle robots can find utility at residences and nursing facilities by providing an anchor of support during postural transitions and assisting with activities of daily living.

For assisting elderly and disabled people, grab bars are often installed in various places in residential homes, hospitals, and care facilities. Those rails may be fixed to walls and other structures where older adults and disabled people (collectively termed, Elderly) frequently use them for supporting their body. However, the suitable walls and structures for rail installation may be limited and may not be optimal locations for securely supporting the body. A novel robot design is described that is capable of navigating the home environment while fully supporting the user's weight.

### EMBODIMENTS

Various embodiments of the devices and systems disclosed herein may be implemented including, for example, the listing and combination of embodiments provided below.
1. A device comprising: a robotic arm, wherein the robotic arm comprises a linkage to the mobile base and one or more handles attached to one end of the arm; and a mobile base, wherein the base comprises wheels; wherein the robotic arm comprises handles and linkages, wherein the linkages connect the handles to the mobile base, and wherein the linkages comprise powered joints and multiple degrees of freedom for positioning the handle.
2. The device of embodiment 1, wherein the mobile base is powered with actuators to control movement of the device manually or autonomously.
3. The device of embodiment 1, wherein the mobile base is configured to prevent tipping over during use of the device.
4. The device of embodiment 1, wherein a user applies external forces acts on the system through the handle.
5. The device of embodiment 1, wherein the device can fit through narrow doors or limited spaces.
6. The device of embodiment 1, wherein the robotic arm is configured to memorize various postures for locating the handles in space.
7. The device of embodiment 6, wherein the robotic arm is configured to retrieve a stored set of joint angles and take the corresponding memorized posture.
8. The device of embodiment 7, wherein the robotic arm moves along a trajectory between memorized postures.
9. The device of embodiment 8, wherein the user's body moves, raises, lowers, turns, or changes along a trajectory.
10. The device of embodiment 1, wherein the handles are determined based on ergonomic analysis and evaluation of Elderly's physical and cognitive functions.
11. The device of embodiment 8, wherein the handles are placed at particular locations in space to optimize the movement and body stability of the user.
12. The device of embodiment 1, wherein the device is configured to assist a user to enter of leave a bed.
13. The device of embodiment 1, wherein the device is configured to assist the user in a bathroom.
14. The device of embodiment 1, wherein the device is configured to assist the user in sit or stand transition.
15. The device of embodiment 14, wherein the device is configured to assist the user to use a toilet, chair, or bed.

It should be understood that the subject matter defined in the appended claims is not necessarily limited to the specific implementations described above. The specific implementations described above are disclosed as examples only.

Specific non-limiting embodiments are described in further detail with respect to the figures. It should be understood that the various systems, components, features, and methods described relative to these embodiments may be used either individually and/or in any desired combination as the disclosure is not limited to only the specific embodiments described herein.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A device comprising:
a mobile base;
a robotic arm attached to and supported by the mobile base, wherein the robotic arm comprises a linkage; and
a handle attached to the robotic arm, wherein the handle is configured to be grasped by and support a user during an activity, wherein the robotic arm is configured to position the handle in a desired pose relative to the user during the activity.

2. The device of claim 1, wherein the mobile base comprises one or more wheels.

3. The device of claim 2, wherein the one or more wheels are omni-directional wheels.

4. The device of claim 1, wherein the device is controlled manually via tele-operation.

5. The device of claim 1, wherein the device is controlled automatically.

6. The device of claim 1, wherein the robotic arm is configured to position the handle to optimize the stability of the body of the user during the activity.

7. The device of claim 1, wherein the device is configured to assist the user to transition from a body posture associated with lying down to a body posture associated with sitting.

8. The device of claim 1, wherein the device is configured to assist the user to transition from a body posture associated with sitting to a body posture associated with standing.

9. The device of claim 1, further comprising a sensor configured to sense a force associated with the handle.

10. The device of claim 9, further comprising at least one processor configured to obtain a sensed force from the sensor and control the robotic arm to maintain a pose based on the sensed force.

11. The device of claim 4, further comprising at least one camera configured to obtain an image of the user, and wherein the device is controlled manually based at least in part on the image of the user.

12. A method for assisting a user during an activity, the method comprising:
positioning a robotic arm using a mobile base; and
positioning a handle to be grasped by a user during an activity using the robotic arm.

13. The method of claim 12, wherein position the robotic arm using the mobile base includes controlling one or more wheels on the mobile base to move the mobile base.

14. The method of claim 12, wherein positioning the robotic arm using the mobile base includes controlling the mobile base remotely, and wherein positioning the handle to be grasped by the user during the activity using the robotic arm includes controlling the robotic arm remotely.

15. The method of claim 12, wherein positioning the robotic arm using the mobile base includes controlling the mobile base automatically, and wherein positioning the handle to be grasped by the user during the activity using the robotic arm includes controlling the robotic arm automatically.

16. The method of claim 12, wherein the activity is transitioning the user from a lying down position to a sitting position.

17. The method of claim 12, wherein the activity is transitioning the user from a sitting position to a standing position.

18. The method of claim 12, further comprising sensing a force associated with the handle, and controlling the robotic arm to maintain a pose based at least in part on the sensed force.

19. The method of claim 12, further comprising obtaining an image of the user, and wherein positioning the handle is based at least in part on the image of the user.

20. The method of claim 12, further comprising calibrating the robotic arm and mobile base, wherein calibrating comprises:
moving the robotic arm to a position using the mobile base;
positioning the handle by moving the robotic arm to a pose to assist a user to perform an activity;
storing the position and/or the pose; and
recalling the position and/or the pose and moving the robotic arm to the position and/or the pose.
